(19) United States
(12) Patent Application Publication
(10) Pub. No.: US 2026/0342771 A1
(43) Pub. Date: Oct. 29, 2026

(54) CONNECTOR

(71) Applicant: Stäubli Electrical Connectors AG, Allschwil (CH)

(72) Inventors: Benedikt OHM, Lörrach-Haagen (DE); Guowei LIANG, Hangzhou City (CN); Ana GAGO BENITEZ, Lampenberg BL (CH)

(73) Assignee: Stäubli Electrical Connectors AG, Allschwil (CH)

(21) Appl. No.: 18/997,342

(22) PCT Filed: Jul. 17, 2023
(86) PCT No.: PCT/EP2023/069763

§ 371 Date: Jan. 21, 2025

(30) Foreign Application Priority Data
Jul. 22, 2022 (EP) 22186487.9
Jul. 22, 2022 (EP) 22186490.3

(51) Int. Cl. H04L 9/40

(52) U.S. Cl. CPC H04L 63/0428

(57) ABSTRACT

System having a connector with a sensor configured to measure physical properties of the connector and provide a sensor signal, a microcontroller configured to receive the sensor signal, to pre-process the sensor signal, to provide a pre-processed data package having the sensor signal, and a communication module configured to receive the pre-processed data package; a computer network configured to receive the pre-processed data package from the communication module and to further process the pre-processed data package in order to provide a processed data package; and a computer configured to receive the processed data package and having a processor configured to process the processed data package to obtain information relating to the sensor signal and a display to display said information relating to the sensor signal.

### TECHNICAL FIELD

The present invention relates to a system with a connector, in particular an electrical and/or fluidic connector, according to claim 1.

### PRIOR ART

From prior art it is known to integrate data modules and sensors into connectors. Typically such connectors have their main function to transmit energy, such as fluidic and/or pneumatic energy or signals. In addition such connectors comprise sensors to acquire sensor data relating to physical parameters of the connector.

WO 2017/059843 A1 is just one example showing data transmission from a plug. This publication discloses a device for data transmission from a plug connector housing that includes a data module for storing and forwarding data, a plug connector housing with a cable outlet opening and a threaded cable connection, and an adapter module which has at least one cable passage area.

### SUMMARY OF THE INVENTION

It is an object of the present invention to provide a system having at least one connector which system provides sensor data in a secure way.

This object is solved by the system of claim 1. Therefore the system comprises
at least one connector, in particular an electrical and/or fluidic connector, comprising
   at least one sensor configured to measure physical properties of the connector and to provide a sensor signal based on the measured physical property,
   at least one microcontroller configured to receive said sensor signal, to pre-process said sensor signal, to provide a pre-processed data package comprising said sensor signal,
   at least one communication module which is configured to receive said pre-processed data package from the at least one microcontroller and to provide said pre-processed data package,
a computer network configured to receive said pre-processed data package from the at least one communication module and to further process said pre-processed data package in order to provide a processed data package, and
a computer configured to receive said processed data package, and having a processor configured to process said processed data package to obtain information relating to said sensor signal and a display to display said information relating to said sensor signal.

The microcontroller is further configured to encrypt said pre-processed data package such that said pre-processed data package is encrypted before its transmission to the computer network.

The encryption of the pre-processed data package on the level of the connector is advantageous as the sensor data in said pre-processed data package is protected from unauthorized access and use. Furthermore, the data as contained in the pre-processed data package is encrypted it cannot be manipulated.

The pre-processed sensor signal is preferably a voltage value as obtained from the sensor. The voltage value correlates to the physical property. Examples of the physical property are provided below. During the further processing of the data package said voltage value is then converted to said physical value which is then displayed. Alternatively, the pre-processed sensor signal may also be converted such that the voltage value is converted into the physical value in the microcontroller.

The term sensor signal is to be understood to encompass one single sensor signal or at least one sensor signal.

The encryption of the data package is provided on the level of the connector. This has the advantage that the data is transmitted encrypted from the connector to the computer network. Therefore, the data package can be secured against possible fraudulent modification and it is not accessible for an unauthorised access.

Preferably, the microcontroller of the connector is connected via a data connection to the computer network. This data connection can be a wireless connection, for example WLAN, Bluetooth, Zigbee or any other wireless protocol, or a wire connection, for example a LAN connection.

Preferably, the computer network is connected to the computer via a data connection. This data connection can be a wireless connection, for example WLAN, Bluetooth, Zigbee or any other wireless protocol, or a wire connection, for example a LAN connection.

The computer network is preferably a cloud structure.

The computer is preferably a personal computer, a notebook, a smart phone or a tablet or any other computer. The computer is configured to display said information by means of a computer program such as an app, a web-based front end or a website.

The data as displayed can be real time data and/or historical data. In other embodiments that measurements are performed regularly in specific time intervals. It is then possible to submit the pre-processed data package instantly after the measurement or to submit several measurement results in one pre-processed data package.

Preferably, the connector comprises a unique certificate which is used in the encryption process. Preferably, the encryption is made using a PGP-protocol or a similar protocol. Any other protocol can also be used.

The sensor, the microcontroller and the communication module are preferably provided with electrical power by means of a power supply. The power supply may be a battery on the connector or an electrical cable that is connected to the connector. In other embodiments it is also possible to charge a battery with energy harvesting.

In a first embodiment, the communication module is linked directly to the computer network. Due to the direct connection, data can be transferred individually and there is no synchronisation in terms of the transmission rate necessary.

In a second embodiment, the system comprises a gateway, which gateway is arranged between the communication module and the computer network, wherein said pre-processed data package is sent from the communication module via the gateway to the computer network. The advantage here is that the connector no longer have to connect to the computer network individually, but everything is controlled via said gateway. This significantly simplifies device management in the computer network and also reduces the required bandwidth.

Preferably, the microcontroller comprises a time element which is configured to add a time stamp to a said sensor signal, whereby the sensor signal and the time stamp are provided with said pre-processed data package.

The time element is embedded or integrated on the microcontroller. The time element can also be designated as clock.

Adding a timestamp has the advantage that users can see when the data was obtained. This enables a user to locate a measured condition or a specific event to the time when the condition was measured all the event happened.

Preferably said computer network comprises a network processor configured to process said pre-processed data package and/or a data storage device configured to store said pre-processed data package.

The data storage device can be provided as cache and/or as a buffer and/or as a long-term storage device. Preferably the received pre-processed data package is stored in said data storage in encrypted form.

Preferably, said network processor
is configured to decrypt said pre-processed data package in order to store and/or to process decrypted sensor data, and/or
said network processor is configured to process said sensor data;
in that said network processor is configured to encrypt said decrypted or said processed sensor data such that said processed data package is encrypted before its transmission from the computer network to the computer.

Preferably the computer comprises a data storage device. The processor of the computer is configured to decrypt said processed data package in order to store and/or to process decrypted sensor data, and/or in that the processor of the computer is configured to process said sensor data; and/or in that the processor of the computer is configured to encrypt said decrypted or said processed sensor data.

The data storage device can be provided as cache and/or as a buffer and/or as a long-term storage device.

Preferably, the computer is connected to a further processing unit.

Preferably, the computer comprises a user interface which is configured to receive user inputs.

Preferably said at least one sensor and/or the microcontroller and/or the communication module are provided on a printed circuit board which is in mounted on the connector.

Preferably the connector comprises a connection interface via which the connector can be connected to a further connector having a connection interface which corresponds to the connection interface of the connector.

Preferably said connection interface is an electrical connection interface to establish an electrical connection between the connector and said further connector. Preferably said connection interface is a fluidic connection interface to establish a fluidic connection between the connector and said further connector. It is also possible that an electrical connection interface and a fluidic connection interface are provided on the same connector and said further connector.

Preferably, the connection interface is a plug structure and/or a socket structure.

Preferably, the connector with the electrical connection interface comprises a further electrical connection interface to which at least one cable is connected. Preferably, the connector with the fluidic connection interface comprises a further fluidic connection interface to which at least one pipe is connected. Preferably, said further connection interface is connected to said connection interface with at least one internal connector element.

Preferably, the further connector does not comprise a sensor and the microcontroller. This means that only one connector is provided with elements to measure the physical property.

In other embodiments it is also possible to provide the further connector with the same structure as the connector. With this embodiment it is possible to obtain redundant or additional sensor data.

Preferably, the sensor is chosen from the group of
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or
an acceleration sensor configured to measure an acceleration, which is said physical property; and/or
an mating cycle sensor configured to measure the number of mating cycles, which are said physical property; and/or
a flow sensor configured to measure a volume flow, which is said physical property.

The mating cycle sensor is preferably a near field communication sensor or a radio frequency identification device. With those devices it may also be possible to identify a connector.

In the specific embodiments it is possible that some of the sensors are provided in a single sensor device. It is for example possible to integrate a temperature sensor and the humidity sensor in a single sensor device.

Preferably, the ambient temperature is the ambient temperature in a housing.

The term “a specific temperature” is to be understood that the temperature at a specific location is measured. For example at a contact element of the connection interface or at a specific location on the housing.

Preferably, the acceleration sensor measures the acceleration along at least one axis, preferably along three axes.

The list as mentioned above mentions one sensor per property. However, it is also possible add more than one sensor to measure the same property.

A method to operate a system according to the description above comprises the steps of:
measuring said physical properties by said at least one sensor and provide a sensor signal based on the measured physical property,
sending said sensor signal from the at least one sensor that said at least one microcontroller,
receiving said sensor signal by the at least one microcontroller,
pre-processing and encrypting said received sensor signal by the at least one microcontroller and providing pre-processed data package comprising said sensor signal,
receiving said pre-processed data package by the at least one communication module,
sending said pre-processed data package by said at least one communication module to said computer network,
receiving said pre-processed data package by said computer network,
further processing said pre-processed data package to a processed data package and providing said processed data package,
sending said processed data package to the computer,
receiving said processed data package by the computer, and
processing said processed data package and obtaining information relating to said sensor signal;
displaying said information relating to said sensor signal on the display.

Preferably before and/or during and/or after the step of further processing said pre-processed data package to a processed data package and providing said processed data package said pre-processed data package or said a processed data package may be stored a data storage.

Preferably the method comprises the step of decrypting the pre-processed data package before the step of further processing said pre-processed data package in the computer network to the processed data package. The decryption is preferably made by the above mentioned network processor.

Alternatively the data processing can be done with the encrypted data or with decrypted data in another step in the computer network.

Preferably the method comprises the step of encrypting the processed data package in the computer network and decrypting said processed data package by the computer.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic view of a system according to a first embodiment; and

FIG. 2 shows a schematic view of a system according to a second embodiment.

### DESCRIPTION OF PREFERRED EMBODIMENTS

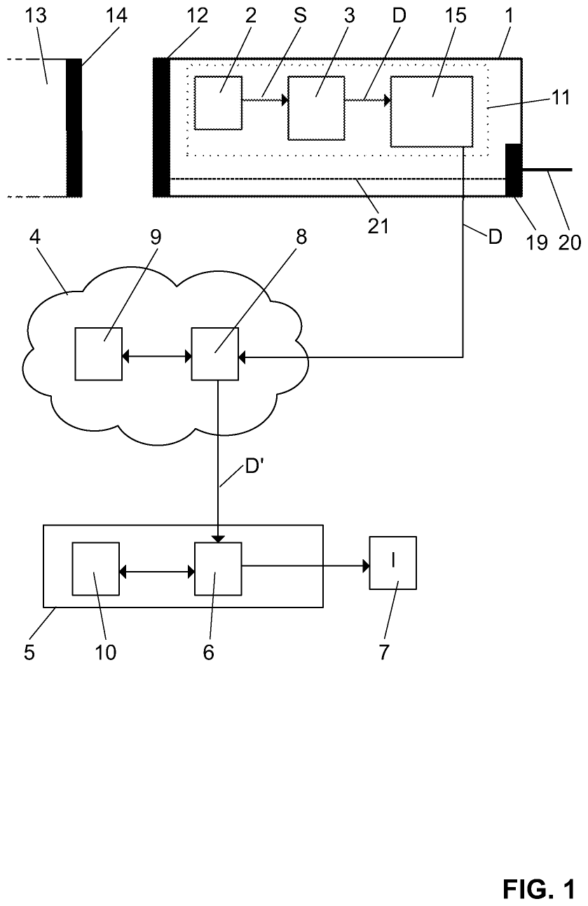

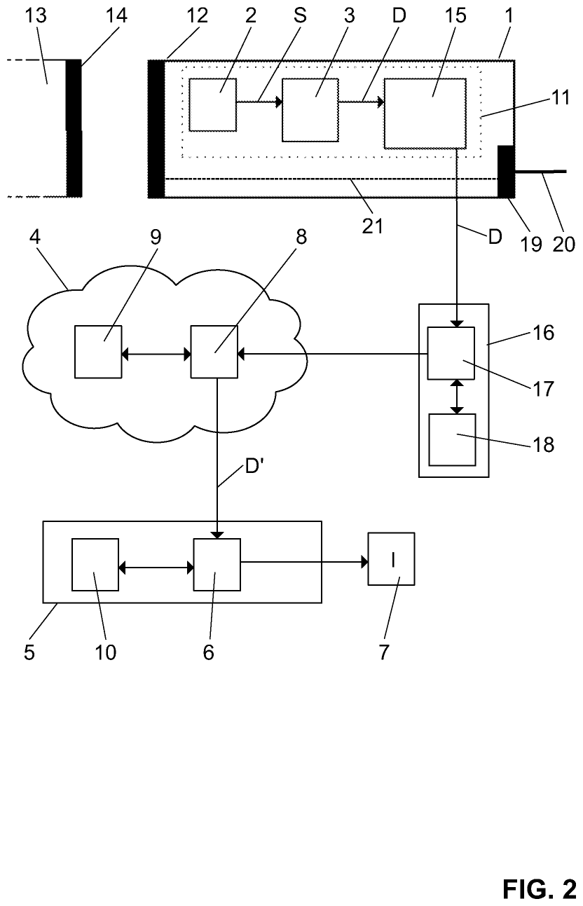

FIGS. 1 and 2 show schematic views of a system according to the first and a second embodiment of the present invention.

The system comprising at least one connector 1, a computer network 4 and a computer 5.

The at least one connector 1 is preferably a fluidic and/or electrical connector. The at least one connector 1 comprises a connection interface 12 which is configured such that a fluidic and/or an electrical contact can be provided with a corresponding connection interface 14 of a further connector 13. The electrical parts of the connection interfaces 12, 14 are preferably provided as plug and socket structures. The fluidic parts of the connection interfaces 12, 14 are preferably provided as fluid couplings. Preferably, the at least one connector 1 comprises a further connection interface 19 to which an external connector 20, such as a cable or a pipe, is electrically or fluidically connected. Furthermore, the connector comprises at least one internal connector element which connects the connection interface 12 with the further connection interface 19 within the connector 1. The at least one internal connector element is preferably an electrical connector element or fluidic connector element. The at least one internal connector element 21 as well as the mentioned connection interfaces 12, 19 can be part of a connector module which can be assembled with a connector frame structure or a connector housing.

Furthermore the at least one connector 1 comprises at least one sensor 2, at least one micro controller 3 and at least one communication module 15.

The at least one sensor 2 is configured to measure physical properties of the connector 1 and to provide a sensor signal S based on the measured physical property. Examples of physical properties are mentioned below. The at least one sensor 2 are physically arranged on the connector 1, preferably on a printed circuit board 11 that is located within a housing of the connector 1. The at least one sensor 2 is arranged based on the physical property to be measured. The sensor signal S is preferably a voltage that correlates with the physical property.

The at least one microcontroller 3 is configured to receive said sensor signal S, to pre-process said sensor signal, to provide a pre-processed data package D comprising said sensor signal S. The at least one sensor is thereby in an electrical signal connection with the microcontroller and via this connection the sensor signal S is transmitted from the at least one sensor 2 to the microcontroller 3.

The at least one microcontroller 3 is further configured to encrypt said pre-processed data package D such that said pre-processed data package D is encrypted before its transmission to the computer network 4.

The at least one communication module 15 is configured to receive said pre-processed data package D from the at least one microcontroller and to provide said pre-processed data package D for further use. The communication module 15 can be a wireless communication module and/or a wired communication module. The wireless communication module transmits the pre-processed data package D over a wireless connection to the computer network 4 under a respective protocol, such as WLAN, Bluetooth, Zigbee or the like. The wired communication module transmits the pre-processed data package D over a wired connection to the computer network 4 with a physical wired connection.

Preferably the at least one microcontroller 3 and the at least one communication module 15 are also arranged on the same printed circuit board 11 as the at least one sensor 2.

The computer network 4 is configured to receive said pre-processed data package D from the at least one communication module 15 and to further process said pre-processed data package D in order to provide a processed data package D′.

The computer 5 is configured to receive said processed data package D′, and having a processor 6 configured to process said processed data package D′ to obtain information I relating to said sensor signal S and a display 7 to display said information relating to said sensor signal.

As mentioned above the pre-processed data package D is encrypted. Preferably it is decrypted by the computer network 4 before the pre-processed data package D is further processed to obtain said processed data package D′. Further it is possible that in the computer network 4 said processed data package D′ is encrypted again before it is sent to the computer 5. In this case the processed data package D′ has to be decrypted by the computer 5. Alternatively it is also possible to process the encrypted pre-processed data package D to obtain said processed data package D′ without any decryption beforehand.

In the first embodiment according to FIG. 1 the communication module 15 is linked directly to the computer network 4.

In the second embodiment according to FIG. 2 the system comprises a gateway 16. The gateway 16 is arranged between the communication module 15 and the computer network 4. Said pre-processed data package D is sent from the communication module 15 via the gateway 16 to the computer network 4. The gateway 16 comprises a communication module 17 and an optional data processing unit 18. In the present case one connector 1 is linked to the gateway 16. However, it is also possible to connect more than one or a plurality of connectors with the gateway 16.

In both embodiments, the microcontroller 3 preferably comprises a time element which is configured to add a time stamp to a said sensor signal, whereby the sensor signal and the time stamp are provided with said pre-processed data package.

In both embodiments, the said computer network 4 comprises a network processor 8 configured to process said pre-processed data package D. Preferably, the network processor 8 is configured to decrypt the pre-processed data package D, to process the pre-processed data package D to the processed data package D′ and in an optional step to encrypt the processed data package D′.

Preferably the computer network also comprises a data storage device 9 configured to store said data package D. The data storage device 9 can be a buffer or cache or a long term storage element.

Preferably, the computer 5 comprises a data storage device 10.

The processor 6 of the computer 5 is configured to decrypt said processed data package D′ in order to store or process decrypted sensor data. Generally the processor 6 of the computer 5 is configured to process said sensor data. Furthermore, the processor 6 of the computer 5 is configured to encrypt said decrypted or said processed sensor data.

As mentioned above several different sensors can be arranged. Preferably the sensor is chosen from the group of
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or
an acceleration sensor configured to measure an acceleration, which is said physical property; and/or
an mating cycle sensor configured to measure the number of mating cycles, which are said physical property; and/or
a flow sensor configured to measure a volume flow, which is said physical property.

A method to operate a system according to the description above comprises the steps of:
measuring said physical properties by said at least one sensor 2 and provide a sensor signal S based on the measured physical property,
sending said sensor signal S from the at least one sensor 2 that said at least one microcontroller 3,
receiving said sensor signal S by the at least one microcontroller 3,
pre-processing and encrypting said received sensor signal S by the at least one microcontroller 3 and providing pre-processed data package D comprising said sensor signal S,
receiving said pre-processed data package D by the at least one communication module 15,
sending said pre-processed data package D by said at least one communication module 15 to said computer network 4,
receiving said pre-processed data package D by said computer network 4,
further processing said pre-processed data package D to a processed data package D′ and providing said processed data package D′,
sending said processed data package D′ to the computer 5,
receiving said processed data package D′ by the computer 5, and
processing said processed data package D′ and obtaining information I relating to said sensor signal S;
displaying said information I relating to said sensor signal S on the display 7.

Optionally the method comprises the step of decrypting the pre-processed data package D before the step of further processing said pre-processed data package D in the computer network 4 to the processed data package D.

Optionally the method comprises the step of encrypting the processed data package D′ in the computer network 4 and decrypting said processed data package D′ by the computer.

### LIST OF REFERENCE SIGNS

1 connector
2 sensor
3 microcontroller
4 computer network
5 computer
6 processor
7 display
8 network processor
9 data storage device
10 data storage device
11 printed circuit board
12 connection interface
13 further connector
14 connection interface
15 communication module
16 gateway
17 communication module
18 data processing unit
19 further connection interface
20 cable/pipe
21 internal connection element
D pre-processed data package
D′ processed data package
I Information
S sensor signal

1-15. (canceled)

16. A system comprising a
at least one connector comprising
at least one sensor configured to measure physical properties of the connector and to provide a sensor signal based on the measured physical property,
at least one microcontroller configured to receive said sensor signal, to pre-process said sensor signal, to provide a pre-processed data package comprising said sensor signal,
at least one communication module which is configured to receive said pre-processed data package from the at least one microcontroller and to provide said pre-processed data package,
a computer network configured to receive said pre-processed data package from the at least one communication module and to further process said pre-processed data package in order to provide a processed data package, and
a computer configured to receive said processed data package, and having a processor configured to process said processed data package to obtain information relating to said sensor signal and a display to display said information relating to said sensor signal,
wherein the microcontroller is further configured to encrypt said pre-processed data package such that said pre-processed data package is encrypted before its transmission to the computer network.

17. The system according to claim 16, wherein the connector is an electrical and/or fluidic connector.

18. The system according to claim 16, wherein the communication module is linked directly to the computer network; or wherein the system comprises a gateway, which gateway is arranged between the communication module and the computer network, wherein said pre-processed data package is sent from the communication module via the gateway to the computer network.

19. The system according to claim 16, wherein the microcontroller comprises a time element which is configured to add a time stamp to a said sensor signal, whereby the sensor signal and the time stamp are provided with said pre-processed data package.

20. The system according to claim 16, wherein said computer network comprises a network processor configured to process said pre-processed data package and/or a data storage device configured to store said data package.

21. The system according to claim 20, wherein said network processor is configured to decrypt said pre-processed data package in order to store and/or to process decrypted sensor data, and/or wherein said network processor is configured to process said sensor data; and/or wherein said network processor is configured to encrypt said decrypted or said processed sensor data such that said processed data package is encrypted before its transmission from the computer network to the computer and/or wherein the received pre-processed data package is stored in said data storage in encrypted form.

22. The system according to claim 16, wherein the computer comprises an optional data storage device, wherein the processor of the computer is configured to decrypt said processed data package in order to store and/or to process decrypted sensor data, and/or wherein the processor of the computer is configured to process said sensor data; and/or wherein the processor of the computer is configured to encrypt said decrypted or said processed sensor data.

23. The system according to claim 16, wherein the computer is connected to a further processing unit and/or wherein the computer comprises a user interface which is configured to receive user inputs.

24. The system according to claim 16, wherein said at least one sensor and/or the microcontroller and/or the communication module are provided on a printed circuit board which is in mounted on the connector.

25. The system according to claim 16, wherein the connector comprises a connection interface via which the connector can be connected to a further connector having a connection interface which corresponds to the connection interface of the connector.

26. The system according to claim 25, wherein the connector comprises a further connection interface to which an external connector is connected, wherein said further connection interface is connected to said connection interface with at least one internal connector element.

27. The system according to claim 16, wherein the sensor is chosen from the group of
a temperature sensor configured to measure an ambient temperature, which is said physical property; and/or
a temperature sensor configured to measure a specific temperature, which is said physical property; and/or
a humidity sensor configured to measure an ambient humidity, which is said physical property; and/or
an air pressure sensor configured to measure an ambient air pressure, which is said physical property; and/or
an altitude sensor configured to measure an altitude, which is said physical property; and/or
a vibration sensor configured to measure vibrations, which is said physical property; and/or
an optical sensor configured to measure illuminance, which is said physical property; and/or
a tilt sensor configured to measure a tilt, which is said physical property; and/or
an acceleration sensor configured to measure an acceleration, which is said physical property; and/or
an mating cycle sensor configured to measure the number of mating cycles, which are said physical property; and/or
a flow sensor configured to measure a volume flow, which is said physical property.

28. A method to operate a system said system comprising a
at least one connector comprising
at least one sensor configured to measure physical properties of the connector and to provide a sensor signal based on the measured physical property,
at least one microcontroller configured to receive said sensor signal, to pre-process said sensor signal, to provide a pre-processed data package comprising said sensor signal,
at least one communication module which is configured to receive said pre-processed data package from the at least one microcontroller and to provide said pre-processed data package,
a computer network configured to receive said pre-processed data package from the at least one communication module and to further process said pre-processed data package in order to provide a processed data package, and
a computer configured to receive said processed data package, and having a processor configured to process said processed data package to obtain information relating to said sensor signal and a display to display said information relating to said sensor signal,
wherein the microcontroller is further configured to encrypt said pre-processed data package such that said pre-processed data package is encrypted before its transmission to the computer network, wherein
said method comprises the steps of:
measuring said physical properties by said at least one sensor and provide a sensor signal based on the measured physical property,
sending said sensor signal from the at least one sensor to that said at least one microcontroller,
receiving said sensor signal by the at least one microcontroller,
pre-processing and encrypting said received sensor signal by the at least one microcontroller and providing pre-processed data package comprising said sensor signal,
receiving said pre-processed data package by the at least one communication module,
sending said pre-processed data package by said at least one communication module to said computer network,
receiving said pre-processed data package by said computer network,
further processing said pre-processed data package to a processed data package and providing said processed data package,
sending said processed data package to the computer,
receiving said processed data package by the computer, and
processing said processed data package and obtaining information relating to said sensor signal;
displaying said information relating to said sensor signal on the display.

29. The method according to claim 28, comprising the step of decrypting the pre-processed data package before the step of further processing said pre-processed data package in the computer network to the processed data package.

30. The method according to claim 28, comprising the step of encrypting the processed data package in the computer network and decrypting said processed data package by the computer.

31. A computer program product comprising instructions which, when the program is executed by said computer network or said computer, cause the computer network or the computer to carry out the steps of the method of claim 28.
